(19) United States
(12) Patent Application Publication
(10) Pub. No.: US 2025/0346338 A1
(43) Pub. Date: Nov. 13, 2025

(54) SEAL RING, SHAFT SEAL ASSEMBLY, SHIP PROPELLER AND SHIP

(71) Applicant: Shantou Xinshuo Technology Co., Ltd., Shantou (CN)

(72) Inventors: Dapeng ZHU, Shantou (CN); Xiaodong CAI, Shantou (CN); Ting LEI, Shantou (CN); Qing ZHANG, Shantou (CN); Tingzhi YAN, Shantou (CN)

(21) Appl. No.: 18/752,477

(22) Filed: Jun. 24, 2024

(30) Foreign Application Priority Data
May 8, 2024 (CN) 2024105627022

(51) Int. Cl. B63H 23/32

(52) U.S. Cl. CPC B63H 23/321; B63H 2023/327

(57) ABSTRACT

A seal ring includes an outer ring body and an inner ring body. The inner ring body is located inside the outer ring body, and the inner ring body is connected to the outer ring body; and an annular cavity is provided between the inner ring body and the outer ring body, a threaded spiral rib is provided on an inner ring surface of the inner ring body, and the threaded spiral rib extends along a length direction of a central groove of the inner ring body and a circumferential direction of the central groove.

### TECHNICAL FIELD

The present invention pertains to the technical field of ships, and specifically pertains to a seal ring, a shaft seal assembly, a ship propeller and a ship.

### BACKGROUND

A ship toy is equipped with a screw propeller, and the screw propeller rotates and acts on water, generating power to drive a hull to travel. The hull is usually equipped with a motor and a drive shaft, the hull is provided with a through-shaft groove for the drive shaft, the drive shaft rotatably penetrates through the through-shaft hole, the screw propeller is connected to the drive shaft, and the motor is connected to the drive shaft, and there is a gap between the drive shaft and the through-shaft hole. When the hull is on a water surface for a long time, there is a problem of water seeping into the gap and eventually seeping into an interior of the hull, affecting proper operation of various modules in the hull, and resulting in certain risks.

In view of the problems, the present invention is proposed.

### SUMMARY

The present invention provides a seal ring, a shaft seal assembly, a ship propeller and a ship.

The present application provides the following technical solutions:

A first object of the present application is to provide a seal ring comprising:
an outer ring body; and
an inner ring body, wherein the inner ring body is located inside the outer ring body, and the inner ring body is connected to the outer ring body; and an annular cavity is provided between the inner ring body and the outer ring body, a threaded spiral rib is provided on an inner ring surface of the inner ring body, and the threaded spiral rib extends along a length direction of a central groove of the inner ring body and a circumferential direction of the central groove.

Optionally, the seal ring comprises a tightening member; and
the tightening member is located in the annular cavity, and the tightening member is sleeved on the inner ring body.

Optionally, the tightening member is an annular elastic member.

Optionally, a face of the inner ring body facing the outer ring body is provided with an annular groove; and
the tightening member is embedded in the annular groove.

Optionally, the inner ring body and the outer ring body are connected by a connecting ring, and the annular cavity is formed among the outer ring body, the inner ring body and the connecting ring; and
the annular groove is located on a side of the inner ring body away from the connecting ring.

A second object of the present application is to provide a shaft seal assembly comprising:
a sleeve having a cavity and two ports communicating with the cavity;
a bearing provided in the cavity, wherein an outer ring of the bearing is fitted to an inner wall of the sleeve; and
the seal ring described above, wherein the seal ring is located in a mounting cavity, and the outer ring body of the seal ring is fitted to the inner wall of the sleeve.

Optionally, the shaft seal assembly comprises two seal rings, and the two seal rings are spaced apart; and
the bearing is located between the two seal rings.

Optionally, the sleeve is provided with an oil injection opening communicating with the cavity.

Optionally, the sleeve has a central cavity and end cavities on both sides of the central cavity;
an inner diameter of the central cavity is smaller than an inner diameter of the end cavities, and an annular step surface is formed between the central cavity and the end cavities; and
one bearing and one seal ring are provided in each of the end cavities, and the bearing is located between the seal ring and the annular step surface.

A third object of the present application is to provide a ship propeller comprising:
a propeller body, wherein the propeller body has a through-shaft groove, a mounting groove and a mouth, the through-shaft groove communicates with the mounting groove, the mouth is located on a side of the mounting groove away from the through-shaft groove, and the mouth communicates with the mounting groove;
the shaft seal assembly described above, wherein the shaft seal assembly is embedded in the mounting groove;
a stop detachably connected to the propeller body, wherein the stop closes a portion of the mouth, and the stop is limited at one end of the shaft seal assembly;
a drive shaft, wherein the drive shaft penetrates through the through-shaft groove, the shaft seal assembly and the mouth, and the drive shaft is connected to a screw propeller; and
a main drive assembly, wherein the main drive assembly is arranged on the propeller body, and the main drive assembly is drivingly connected to the drive shaft.

A fourth object of the present application is to provide a ship comprising:
a ship body; and
the ship propeller described above, wherein the propeller body of the ship propeller is connected to the ship body.

By adopting the above technical solutions, the present application has the following beneficial effects:

The inner ring body of the seal ring according to embodiments of the present application is in close contact with the drive shaft of the ship propeller, and during rotation of the drive shaft, the threaded spiral rib is squeezed, compressing a gap between the threaded spiral rib and the drive shaft, and pushing out a liquid that seeps between the drive shaft and the seal ring, thus preventing the liquid from entering an interior of a cabin.

### BRIEF DESCRIPTION OF THE DRAWINGS

The accompanying drawings, which are incorporated in and constitute a part of the present application, are included to provide a further understanding of the present invention. Illustrative embodiments of the present invention and the description thereof are included to illustrate the present invention, but are not to be construed as unduly limiting the present invention. Apparently, the accompanying drawings in the following description are merely some rather than all embodiments of the present invention, and a person of ordinary skill in the art may still derive other drawings from these accompanying drawings without creative efforts.

FIG. 1 is a structural schematic view of a ship propeller according to an embodiment of the present invention;

FIG. 2 illustrates a view of FIG. 1 observed from another perspective;

FIG. 3 is a section view of a ship propeller according to an embodiment of the present invention;

FIG. 4 is a structural schematic view of a retrograde adjustment member of a ship propeller according to an embodiment of the present invention;

FIG. 5 is a structural schematic view of a shaft seal assembly provided on a ship propeller according to an embodiment of the present invention;

FIG. 6 is a structural schematic view of a seal ring according to an embodiment of the present invention; and

FIG. 7 is a section view of a seal ring according to an embodiment of the present invention.

Reference numerals in the drawings: 1. seal ring; 11. outer ring body; 12. inner ring body; 121. threaded spiral rib; 122. annular groove; 13. connecting ring; 14. tightening member; 2. sleeve; 21. oil injection opening; 3. bearing; 4. propeller body; 41. mounting groove; 42. first water flow channel; 43. water intake; 44. support plate; 5. stop; 6. drive shaft; 61. screw propeller; 7. main drive assembly; 8. direction adjustment member; 81. second water flow channel; 82. drain outlet; 83. connecting seat; 9. retrograde adjustment member; 91. retrograde flow channel; 92. diverting rib; 93. water inlet; 10. first steering gear; 20. first connecting rod assembly; 30. second steering gear; 40. second connecting rod assembly; a. shaft seal assembly; and b. stopper body.

### DESCRIPTION OF THE EMBODIMENTS

In order to make the objects, technical solutions and advantages of the embodiments of the present invention more clear, the technical solutions in the embodiments of the present invention will be clearly and completely described below in conjunction with the accompanying drawings in the embodiments of the present invention. The embodiments described below are for illustrative purposes only and are not intended to limit the scope of the present invention.

In the description of the present invention, it should be noted that the terms “upper”, “lower”, “inner”, “outer” and the like indicate orientations or positional relationships based on the orientations or positional relationships shown in the drawings, and are only for convenience of description and simplification of description, but do not indicate or imply that the device or element to be referred must have a specific orientation, be constructed and be operated in a specific orientation, and thus, should not be construed as limiting the present invention.

In the description of the present invention, it should be noted that, unless expressly and specifically defined otherwise, the terms “mounted” and “connected” are to be interpreted broadly, and may, for example, be fixedly or detachably or integrally connected; may be mechanically connected or electrically connected; or may be directly connected or indirectly connected through an intermediary. The specific meaning of the above terms in the present invention can be understood by those of ordinary skill in the art from the specific context.

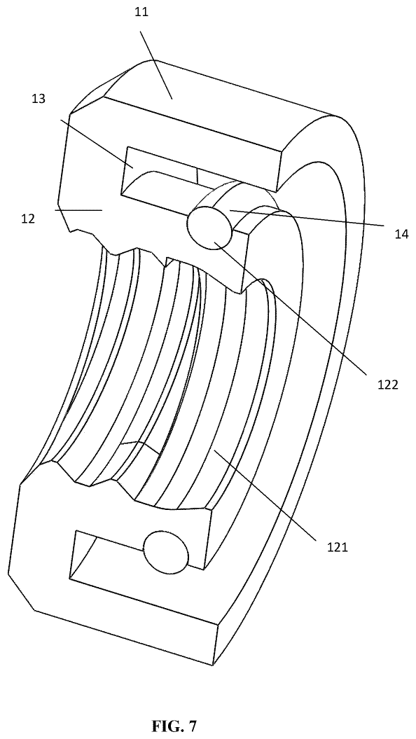

Referring to FIGS. 6 and 7, an embodiment of the present application provides a seal ring 1 comprising an outer ring body 11 and an inner ring body 12, wherein the inner ring body 12 is located inside the outer ring body 11, and the inner ring body 12 is connected to the outer ring body 11; and an annular cavity is provided between the inner ring body 12 and the outer ring body 11, a threaded spiral rib 121 is provided on an inner ring surface of the inner ring body 12, and the threaded spiral rib 121 extends along a length direction of a central groove of the inner ring body 12 and a circumferential direction of the central groove. The seal ring 1 according to an embodiment of the present application can be used on a toy ship, the inner ring body 12 may be in close contact with a drive shaft 6 of a ship propeller, and during rotation of the drive shaft 6, the threaded spiral rib 121 is squeezed, compressing a gap between the threaded spiral rib 121 and the drive shaft 6, and pushing out a liquid that seeps between the drive shaft 6 and the seal ring 1 in a reverse direction, thus preventing the liquid from entering an interior of a cabin.

Specifically, the outer ring body 11 may be of a rigid or semi-rigid structure to facilitate an interference fit with an inner wall of a sleeve 2 on a shaft seal assembly a. The inner ring body 12 is made of a flexible material or is of a semi-rigid structure, and may be in close contact with the drive shaft 6 of a ship, thus functioning as a seal. The threaded spiral rib 121 is arranged on a face of the inner ring body 12 facing the drive shaft 6, the threaded spiral rib 121 is an integral convex rib, a direction of rotation of the threaded spiral rib 121 is consistent with a direction of rotation of the drive shaft 6, and a spiral channel is formed between the threaded spiral rib 121 and the drive shaft 6. During rotation of the drive shaft 6, the spiral channel may be compressed to force out the liquid that seeps into the channel in a reverse direction, thus preventing the liquid from entering an interior of the ship.

In some possible embodiments, the seal ring 1 comprises a tightening member 14, the tightening member 14 is located in the annular cavity, the tightening member 14 is sleeved on the inner ring body 12, and under the action of a tightening force of the tightening member 14, an inner ring surface of the inner ring body 12 is closely fitted to an outer surface of the drive shaft 6.

In some possible embodiments, the tightening member 14 is an annular elastic member. For example, the tightening member may be a rubber band, an annular spring, a rubber ring or the like that continuously and effectively applies the tightening force to the inner ring body 12.

In some possible embodiments, a face of the inner ring body 12 facing the outer ring body 11 is provided with an annular groove 122, and the tightening member 14 is embedded in the annular groove 122. The annular groove 122 serves to position the tightening member 14 to prevent the tightening member 14 from falling off.

In some possible embodiments, the inner ring body 12 and the outer ring body 11 are connected by a connecting ring 13, the annular cavity is formed among the outer ring body 11, the inner ring body 12 and the connecting ring 13, and the annular groove 122 is located on a side of the inner ring body 12 away from the connecting ring 13. The connecting ring 13 is located at one end of the inner ring body 12, and the other end of the inner ring body 12 is suspended and is more easily deformed, and by providing the tightening member 14 at the end, the inner ring body 12 and the drive shaft 6 can be advantageously brought into close contact.

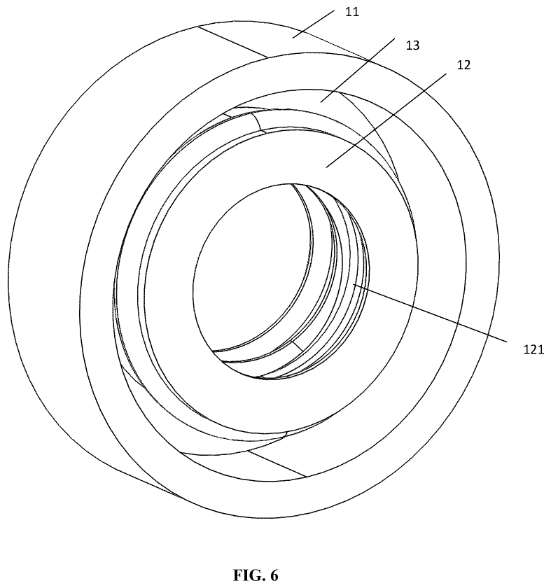

Referring to FIG. 5, an embodiment of the present application also provides a shaft seal assembly a comprising a sleeve 2, a bearing 3 and the seal ring 1 as described above. The sleeve 2 has a cavity and two ports communicating with the cavity; the bearing 3 is arranged in the cavity; an outer ring of the bearing 3 is adhered to the inner wall of the sleeve 2; the seal ring 1 is located in the mounting cavity; and the outer ring body 11 of the seal ring 1 is fitted to an inner wall of the sleeve 2. The outer ring body 11 of the seal ring 1 may be of a rigid structure, and the outer ring body 11 and the inner wall of the sleeve 2 may be in close contact. For example, the outer ring body 11 is arranged in the cavity with an interference fit.

In some possible embodiments, the shaft seal assembly a comprises two seal rings 1, the two seal rings 1 are spaced apart, and the bearing 3 is located between the two seal rings 1.

In the present embodiment, the two seal rings 1 are located at both ends of the sleeve 2 to serve as a double-layer seal, thus providing good waterproofing. A seal oil may be provided in a space formed between the two seal rings 1 to further function as a seal. The seal oil may be accommodated between the two seal rings 1, and arrangement of the seal rings 1 prevents the seal oil from leaking out.

In some possible embodiments, the sleeve 2 is provided with an oil injection opening 21 communicating with the cavity, and the seal oil may be filled to the sleeve 2 through the oil injection opening 21.

In some possible embodiments, the sleeve 2 has a central cavity and end cavities located on both sides of the central cavity, an inner diameter of the central cavity is smaller than an inner diameter of the end cavities, an annular step surface is formed between the central cavity and the end cavities, one bearing 3 and one seal ring 1 are provided in each of the end cavities, and the bearing 3 is located between the seal ring 1 and the annular step surface. The oil injection opening 21 may be located between two bearings 3. A propeller body 4 is provided with an avoidance port corresponding to the oil injection opening 21 of the sleeve 2, and the avoidance port may be detachably provided with a stopper body b for sealing or opening the avoidance port to facilitate oil injection.

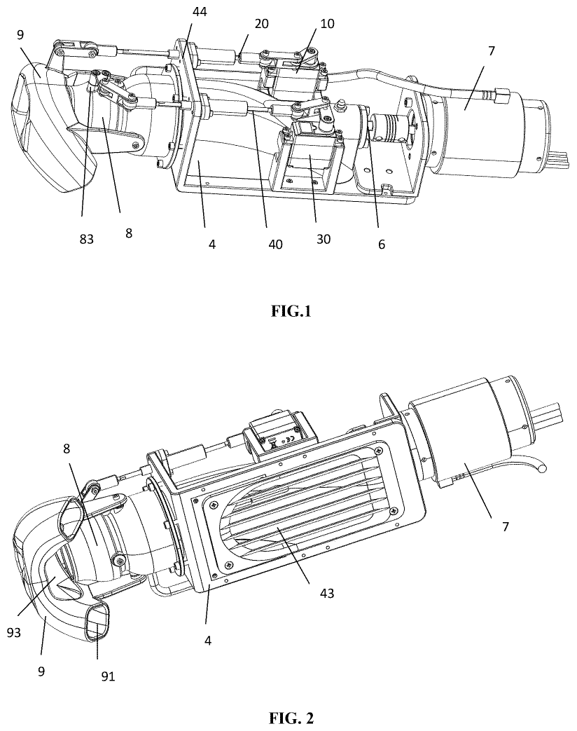

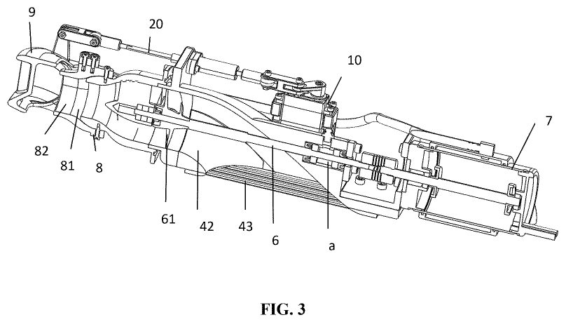

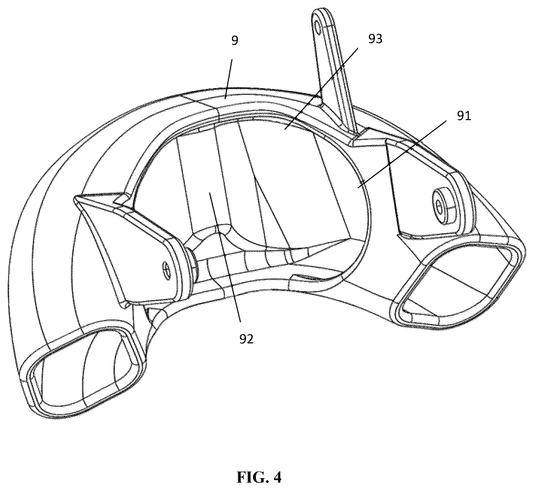

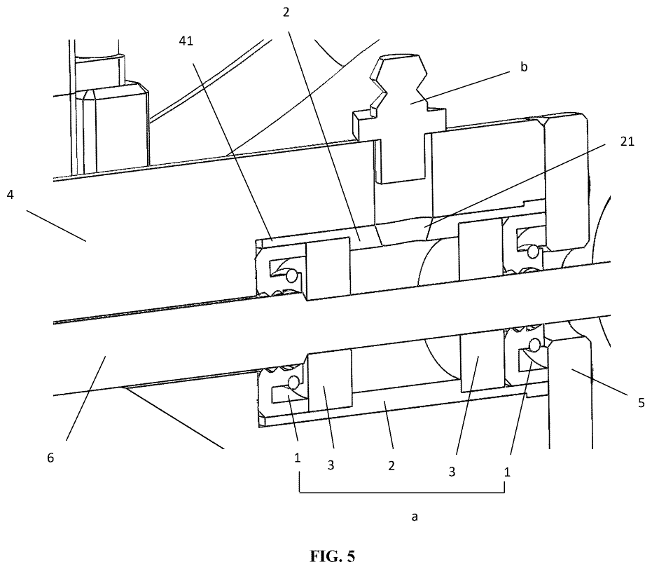

Referring to FIGS. 1 to 5, an embodiment of the present disclosure provides a ship propeller comprising: a propeller body 4, a shaft seal assembly a, a stop 5, a drive shaft 6 and a main drive assembly 7. The propeller body 4 has a through-shaft groove, a mounting groove 41 and a mouth, the through-shaft groove communicates with the mounting groove 41, the mouth is located on a side of the mounting groove 41 away from the through-shaft groove, and the mouth communicates with the mounting groove 41. The shaft seal assembly a is embedded in the mounting groove 41, the stop 5 is detachably connected to the propeller body 4, the stop 5 closes a portion of the mouth, and the stop 5 is limited at one end of the shaft seal assembly a. The drive shaft 6 penetrates through the through-shaft groove, the shaft seal assembly a, and the mouth. The drive shaft 6 is connected to a screw propeller 61, and the main drive assembly 7 is arranged on the propeller body 4. The main drive assembly 7 is drivingly connected to the drive shaft 6. The main drive assembly 7 may be a motor.

In some possible embodiments, a ship propeller comprises: a propeller body 4, a direction adjustment member 8, a retrograde adjustment member 9, a drive mechanism, a screw propeller 61 and a main drive assembly 7. The propeller body 4 has a first water flow channel 42 and a water intake 43 communicating with the first water flow channel 42. The direction adjustment member 8 is movably connected to the propeller body, the direction adjustment member 8 has a second water flow channel 81 and a drain outlet 82, and the second water flow channel 81 communicates with the first water flow channel 42. The retrograde adjustment member 9 is movably connected to the propeller body 4, and the retrograde adjustment member 9 has a retrograde flow channel 91 and a water inlet 93 communicating with a middle position of the retrograde flow channel 91, and both ends of the retrograde flow channel 91 are respectively bent to extend toward one side of the propeller body 4. The drive mechanism is arranged on the propeller body 4 and is drivingly connected to the direction adjustment member 8 and the retrograde adjustment member 9 respectively. The screw propeller 61 is arranged in the first water flow channel 42, the main drive assembly 7 is arranged on the propeller body 4, and the main drive assembly 7 is drivingly connected to the screw propeller 61. The ship propeller has a forward running state and a retrograde running state. In the forward running state, the drive mechanism drives the retrograde adjustment member 9 to be displaced, so that the water inlet 93 and the drain outlet 82 are misaligned, and the drive mechanism can control the direction adjustment member 8 to swing and adjust a left position and a right position of the drain outlet 82, thereby controlling the ship to travel left and right. In the retrograde running state, the drive mechanism drives the retrograde adjustment member 9 to be displaced, so that the water inlet 93 faces the drain outlet 82. Water discharged from the drain outlet 82 directly enters the water inlet 93, and is discharged by the retrograde adjustment member 9 by changing a flow direction by approximately 180 degrees, thus driving the ship to travel in a reverse direction.

In some possible embodiments, both the direction adjustment member 8 and the retrograde adjustment member 9 are rotatably connected to the propeller body 4, and a direction of rotation of the direction adjustment member 8 is perpendicular to a direction of rotation of the retrograde adjustment member 9. The drive mechanism drives the direction adjustment member 8 to rotate to adjust a direction of travel, and the drive mechanism drives the retrograde adjustment member 9 to swing to switch between the forward running state or the retrograde running state.

Since the direction of rotation of the direction adjustment member 8 is perpendicular to the direction of rotation of the retrograde adjustment member 9, it is convenient to change a position of the retrograde adjustment member 9, so that the water inlet 93 of the retrograde adjustment member 9 misaligns or faces the drain outlet 82 of the direction adjustment member 8.

In some possible embodiments, the drive mechanism comprises a first steering gear 10 and a first connecting rod assembly 20, the first steering gear 10 is arranged on the propeller body 4, and the first connecting rod assembly 20 is connected to the first steering gear 10 at one end and to the retrograde adjustment member 9 at the other end.

The drive mechanism comprises a second steering gear 30 and a second connecting rod assembly 40, the second steering gear 30 is arranged on the propeller body 4, and the second connecting rod assembly 40 is connected to the second steering gear 30 at one end and to the direction adjustment member 8 at the other end.

The first steering gear 10 and the second steering gear 30 are respectively arranged on both sides of the propeller body 4 in a width direction.

In some possible embodiments, the propeller body 4 is provided with a support plate 44, and the first connecting rod assembly 20 and the second connecting rod assembly 40 slidably extend through the support plate 44 respectively.

Through holes are provided in the support plate 44, one connecting rod of the first connecting rod assembly 20 slidably extends through a corresponding through hole, and another connecting rod of the second connecting rod assembly 40 slidably extends through a corresponding through hole.

In some possible embodiments, the direction adjustment member 8 is provided with a connecting seat 83, the connecting seat 83 has an extension plate which extends in a width direction of the propeller body 4, and an end portion of the second connecting rod assembly 40 is hinged to the extension plate.

Driven by the second steering gear 30, the second connecting rod assembly 40 moves telescopically, driving the extension plate to rotate, thereby adjusting an angle of the direction adjustment member 8. The first connecting rod assembly and the second connecting rod assembly may comprise three connecting rods, and adjacent connecting rods are hinged together.

In some possible embodiments, the retrograde adjustment member 9 has two connecting rods fixedly arranged, the two connecting rods are respectively located on both sides of the direction adjustment member 8, the connecting rods are hinged to the propeller body 4, and the two connecting rods may swing up and down.

An inner wall of the retrograde flow channel 91 is provided with a diverting rib 92, and the diverting rib 92 protrudes toward the water inlet 93, and water ejected from the second water flow channel 81 enters the water inlet 93 and is uniformly diverted by the diverting rib 92 to flow toward both ends of the retrograde flow channel 91 respectively.

An embodiment of the present disclosure also provides a ship comprising a ship body and the ship propeller as described above, and the propeller body 4 of the ship propeller is connected to the ship body.

The preferred embodiments of the present application disclosed above are intended only to illustrate the present application. It is not intended to elaborate all details of the preferred embodiments, nor is it intended to limit the present application to only the specific embodiments described. Obviously, many modifications and variations are possible in light of the above teaching. The embodiments were chosen and described in order to best explain the principles and practical application of the present application and to thereby enable those skilled in the art to best understand and utilize the present invention. The present application is to be limited only by the claims, along with their full scope and equivalents.

1. A seal ring, comprising:
an outer ring body; and
an inner ring body, wherein the inner ring body is located inside the outer ring body, and the inner ring body is connected to the outer ring body; and an annular cavity is provided between the inner ring body and the outer ring body, a threaded spiral rib is provided on an inner ring surface of the inner ring body, and the threaded spiral rib extends along a length direction of a central groove of the inner ring body and a circumferential direction of the central groove;
wherein the seal ring comprises a first end and an opposite second end, the annular cavity comprises an opening defined between an inner wall of the outer ring body and an outer wall of the inner ring body, and facing towards the first end of the seal ring, and a bottom opposite to the opening, at least part of the annular cavity, from the opening to the bottom, is empty; and
wherein the seal ring further comprises a tightening member, the tightening member is located in the annular cavity, and the tightening member is sleeved on the inner ring body.

2. (canceled)

3. The seal ring according to claim 1, wherein the tightening member is an annular elastic member.

4. The seal ring according to claim 3, wherein a face of the inner ring body facing the outer ring body is provided with an annular groove; and
the tightening member is embedded in the annular groove.

5. The seal ring according to claim 4, wherein the inner ring body and the outer ring body are connected by a connecting ring, and the annular cavity is formed among the outer ring body, the inner ring body and the connecting ring; and
the annular groove is located on a side of the inner ring body away from the connecting ring.

6. A shaft seal assembly, comprising:
a sleeve having a cavity and two ports communicating with the cavity;
a bearing provided in the cavity, an outer ring of the bearing being fitted to an inner wall of the sleeve; and
the seal ring according to claim 1, the seal ring being located in the cavity, and the outer ring body of the seal ring being fitted to the inner wall of the sleeve.

7. The shaft seal assembly according to claim 6, comprising two seal rings, wherein the two seal rings are spaced apart; and
the bearing is located between the two seal rings.

8. The shaft seal assembly according to claim 6, wherein the sleeve is provided with an oil injection opening communicating with the cavity.

9. The shaft seal assembly according to claim 6, wherein the sleeve has a central cavity and end cavities on both sides of the central cavity;
an inner diameter of the central cavity is smaller than an inner diameter of the end cavities, and an annular step surface is formed between the central cavity and the end cavities; and
one bearing and one seal ring are provided in each of the end cavities, and the bearing is located between the seal ring and the annular step surface.

10. A ship propeller, comprising:
a propeller body, the propeller body having a through-shaft groove, a mounting groove and a mouth, the through-shaft groove communicating with the mounting groove, the mouth being located on a side of the mounting groove away from the through-shaft groove, and the mouth communicating with the mounting groove;
the shaft seal assembly according to claim 6, the shaft seal assembly being embedded in the mounting groove;
a stop detachably connected to the propeller body, the stop closing a portion of the mouth, and the stop being limited at one end of the shaft seal assembly;
a drive shaft, the drive shaft penetrating through the through-shaft groove, the shaft seal assembly and the mouth, and the drive shaft being connected to a screw propeller; and
a main drive assembly, the main drive assembly being arranged on the propeller body, and the main drive assembly being drivingly connected to the drive shaft.

11. A ship, comprising:
a ship body; and
the ship propeller according to claim 10, wherein the propeller body of the ship propeller is connected to the ship body.

12. The seal ring according to claim 1, wherein the bottom of the annular cavity is sealed, and the central groove of the inner ring body is open to two ends thereof.

13. The seal ring according to claim 12, wherein the inner ring body and the outer ring body are connected by a connecting ring, and the annular cavity is formed among the outer ring body, the inner ring body and the connecting ring; and
the bottom of the annular cavity is sealed by the connecting ring.

14. The seal ring according to claim 13, wherein the connecting ring is only located between the inner wall of the outer ring body and the outer wall of the inner ring body at the second end of the seal ring.

15. The seal ring according to claim 14, wherein a height of the inner ring body is less than a height of the outer ring body, such that an end surface of the inner ring body at the first end is lower than an end surface of the outer ring body at the first end.

16. The seal ring according to claim 15, the outer ring body, the inner ring body and the connecting ring are integrally formed into one piece.

17. The seal ring according to claim 1, the outer ring body is a rigid structure, and the inner ring body is made of a flexible material or is a semi-rigid structure.

18. The seal ring according to claim 1, the outer ring body is a semi-rigid structure, and the inner ring body is made of a flexible material.
